(19) United States
(12) Patent Application Publication
(10) Pub. No.: US 2025/0001845 A1
(43) Pub. Date: Jan. 2, 2025

(54) Unfinished Component for a Motor Vehicle Body

(71) Applicant: Bayerische Motoren Werke Aktiengesellschaft, Muenchen (DE)

(72) Inventors: Julian CHALUPSKY, Muenchen (DE); Michael STEIN, Roehrmoos (DE)

(21) Appl. No.: 18/704,972

(22) PCT Filed: Sep. 27, 2022
(86) PCT No.: PCT/EP2022/076824

§ 371 Date: Apr. 26, 2024

(30) Foreign Application Priority Data
Oct. 28, 2021 (DE) 10 2021 128 134.2

(51) Int. Cl. B60J 5/10

(52) U.S. Cl. CPC B60J 5/107

(57) ABSTRACT

An unfinished component for a motor vehicle body has at least one first and one second unfinished shell part, which, in a box-like structural region, delimit a cavity in which is disposed a reinforcing pipe profile which is connected to at least one of the unfinished shell parts by a connection. In order to create an unfinished component which enables simpler and more cost-effective production, respective recesses are disposed in the reinforcing pipe profile. In the profile regions adjoining the recesses, the reinforcing pipe profile is connected to the associated unfinished shell part via respective connections on two sides. A method for producing an unfinished component of this type is also provided.

### BACKGROUND AND SUMMARY

The invention relates to an unfinished component for a motor vehicle body. The invention further relates to a method for producing such an unfinished component.

Such an unfinished component in the form of a tailgate is, for example, already known from DE 10 2018 208 566 A1 and from WO 2009/024256 A1. In this case, the unfinished component or the tailgate comprises a first, inner unfinished shell part and a second, outer unfinished shell part which delimit a carrier-like cavity in a V-shaped, box-like structural region, in which cavity a reinforcing pipe profile is arranged which is connected to at least one of the two unfinished shell parts by a one-sided connection.

Since the reinforcing pipe profiles which serve to stiffen the unfinished component, in the present case the tailgate part, primarily involve internal high-pressure formed parts, these have a profile cross-section which is closed in an encircling manner on the outer circumferential side. Should such a reinforcing pipe profile be connected to at least one of the associated unfinished shell parts, this is currently performed by corresponding one-sided connections, in particular one-sided joining connections, which are brought about in particular by laser welding or soldering, by gluing or the like. In this case, window-like recesses are conventionally punched in the corresponding unfinished shell part, in the edge region of which recesses the unfinished shell part is joined to the reinforcing pipe profile via a corresponding weld seam, gluing or the like. Only the extremely complex and costly one-sided joining method can consequently be used as a result of the one-sided accessibility of the connections or connecting points.

The object of the present invention is therefore to create an unfinished component, as well as a method for the production thereof, by means of which simpler and more cost-effective production can be realized.

This object is achieved by an unfinished component and by a method for producing such an unfinished component in accordance with the independent claims. Advantageous configurations with expedient further developments of the invention are the subject matter of the dependent claims.

The unfinished component according to the invention comprises at least two unfinished shell parts which delimit a cavity in a box-like structural region in the manner of a carrier or a pillar, in which cavity a reinforcing pipe profile is arranged and is fastened by connection to at least one of the unfinished shell parts.

According to the invention, in each case recesses are arranged in the reinforcing pipe profile, in adjoining profile regions of which the reinforcing pipe profile is connected via respective two-sided connections, in particular two-sided joining connections, to the associated unfinished shell part. By virtue of the fact that the reinforcing pipe profile is consequently provided with respective recesses, it is possible to reach the inside of the reinforcing pipe profile with corresponding tools, for example, welding tongs or the like, and as a result of this connect the reinforcing pipe profile in the profile regions adjoining the respective recesses to the associated unfinished shell part via respective two-sided connections. In other words, it is enabled by the respective recesses in the reinforcing pipe profile that the reinforcing pipe profile and the unfinished shell part are accessible on both sides in the region of the respective connection, in particular the respective joining connection, so that the stated two-sided connecting method, for example, a corresponding spot-welding method, but also corresponding riveting or clinching, can be used which requires accessibility on both sides to the unfinished components to be connected. As a result, the production of the respective unfinished component or, in particular, the connection of the reinforcing pipe profile to the at least one of the unfinished shell parts can thus be significantly simplified.

In one advantageous configuration of the invention, the reinforcing pipe profile is connected to the associated unfinished shell part via respective two-sided joining connections. In particular, spot welding is suitable as such a two-sided joining connection.

It is further advantageous if the reinforcing pipe profile is formed as an internal high-pressure formed part into which the respective recesses are incorporated during or after the internal high-pressure forming. Such internal high-pressure formed parts can, as pipe profiles, be adapted particularly well as required to the properties of the unfinished component.

A further advantageous configuration of the invention provides that the unfinished component is formed as a wing part of the vehicle body, in particular as a tailgate, door or hood. Precisely in the case of such components, reinforcing measures by means of reinforcing pipe profiles are particularly expedient in order to achieve, for example, a corresponding stability of the unfinished component.

In a further advantageous configuration of the invention, the inner unfinished shell part is joined to the reinforcing pipe profile. The inner is consequently preferably that unfinished shell part which is connected to the reinforcing pipe profile by means of respective two-sided connections, in particular joining connections.

It has furthermore been shown to be advantageous that the unfinished shell part joined to the reinforcing pipe profile has a substantially U-shaped cross-section in the box-like structural region. As a result of this, a particularly stable connection of the unfinished shell part to the reinforcing pipe profile is produced.

A further advantageous configuration of the invention provides that the unfinished shell part is joined in the region of the U-shaped cross-section at opposite legs to the reinforcing pipe profile via respective joining connections. As a result of this, the respective recess can be used for multiple connections of the unfinished shell part to the reinforcing pipe profile.

It has furthermore been shown to be advantageous that the reinforcing pipe profile and the unfinished shell part joined thereto are formed from base alloys of the same materials. The respective unfinished shell part and the reinforcing pipe profile are consequently produced, for example, from a respective steel alloy or aluminum alloy in order to be able to provide a simple joining method, in particular a simple welding method.

The invention also includes a method for producing an unfinished component for a motor vehicle body, in the case of which at least a first and a second unfinished shell part are connected to one another which delimit a cavity in a box-like structural region, in which cavity a reinforcing pipe profile is arranged which is connected to at least one of the unfinished shell parts by a joining connection, wherein respective recesses are incorporated into the reinforcing pipe profile, in adjoining profile regions of which the reinforcing pipe profile is connected via respective two-sided connections to the associated unfinished shell part. The advantages of the method can be derived from those of the unfinished component.

Further features of the invention will become apparent from the claims, the figures and the description of the figures. The features and combinations of features stated above in the description and the features and combination of features stated below in the description of the features and/or shown solely in the figures can not only be used in the respectively indicated combination, but also in other combinations or on their own.

The invention will now be explained on the basis of a preferred exemplary embodiment and with reference to the drawings.

### BRIEF DESCRIPTION OF THE DRAWINGS

FIG. 1 is a front view of an unfinished component for a motor vehicle body in the form of a tailgate part of which an inner or front unfinished shell part is represented which can be connected to an outer unfinished shell part, not apparent here, and forms in an approximately V-shaped, box-like structural region which extends between upper linking regions for respective hinges of the tailgate and a central, lower region, which structural region delimits a cavity in which an overall likewise approximately V-shaped reinforcing pipe profile for stiffening the tailgate is arranged which is connected to the inner unfinished shell part by respective two-sided connections.

FIG. 2 is a perspective sectional view in cut-out along a sectional plane shown by the line II-II in FIG. 1 and running in the vertical direction of the vehicle and in the longitudinal direction of the vehicle through the unfinished component or the tailgate in the box-like structural region between the two unfinished shell parts, in the cavity of which the reinforcing pipe profile is arranged and connected by respective two-sided joining connections to the associated unfinished shell part.

FIG. 3 is an enlarged perspective view in cut-out of the detail III in FIG. 1, wherein the respective recesses within the reinforcing profile which is approximately rectangular in cross-section, via which recesses the profile regions, which adjoin the respective recesses, of the reinforcing pipe profile are connected to respective legs of the associated unfinished shell part via respective two-sided joining connections.

### DETAILED DESCRIPTION OF THE DRAWINGS

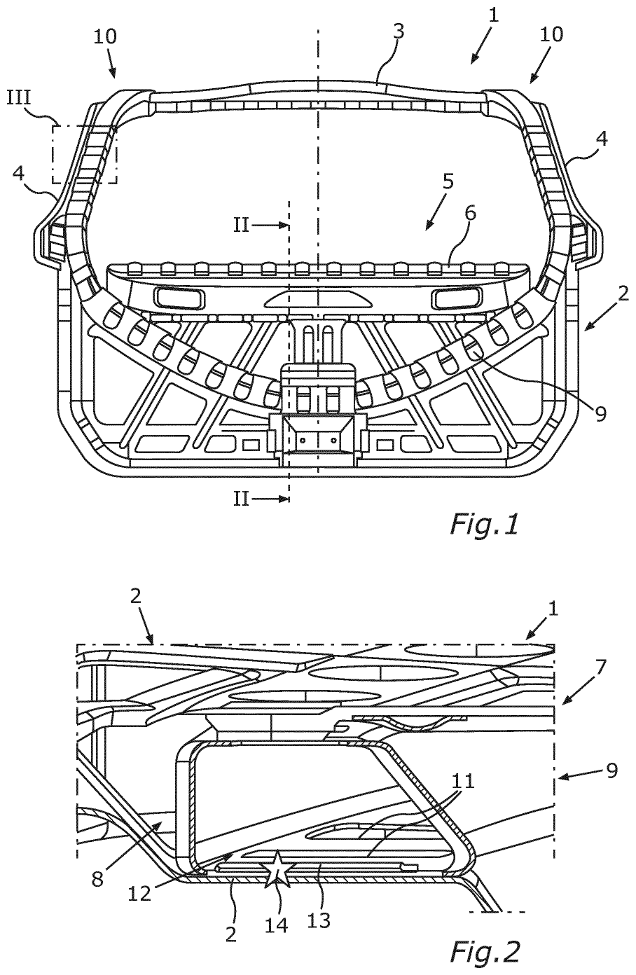

An unfinished component 1 in the form of a tailgate for a motor vehicle body is represented in a front view in FIG. 1. This unfinished component 1 comprises, firstly, a first inner or, in relation to the longitudinal direction of the vehicle, front unfinished shell part 2 which is assembled with a second outer, or, as seen in the longitudinal direction of the vehicle, rear unfinished shell part, which is not visible in the present case, for the formation of the tailgate. The unfinished component 1 or the unfinished shell part 2 has an upper cross member element 3, at the outer ends of which respective pillar parts 4 extend downwards to a support structure 5 which extends upwards up to a door edge molding 6 which, together with the pillar parts 4 and the cross member element 3, forms a frame for accommodating a rear window, which is not visible.

As is thus apparent from FIG. 1, a substantially V-shaped, box-like structural region 7 of the upper part 1 is formed by the first unfinished shell part 2 together with the second unfinished shell part (not visible) which is arranged on the outside of the inner unfinished shell part 2. The structural region 7 delimits a cavity 8 in which a, in the present case, one-piece reinforcing pipe profile 9 is adapted to the shape of the structural region 7 and consequently is likewise substantially V-shaped. This reinforcing pipe profile 9 extends substantially between respective linking points 10 of the unfinished component or the tailgate on the motor vehicle body by means of respective hinges, not visible, and a lower central region of the unfinished component 1 or the tailgate in the region of the support structure 5. The reinforcing pipe profile 9 consequently runs in the present case in box-like structural regions 7 of the unfinished component 1 in the region of the pillar parts 4 and of the support structure 5 which are formed and, at least in regions, delimited by the unfinished shell part 2 and the outer unfinished shell part (not visible).

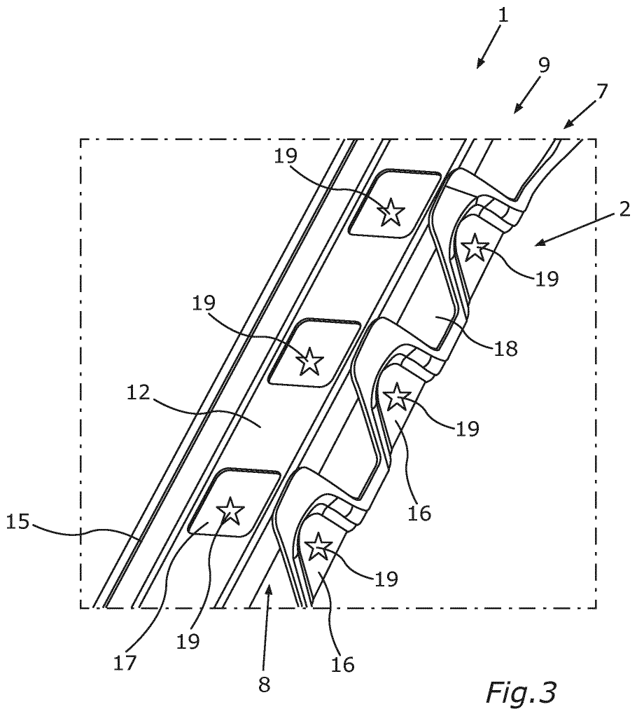

FIG. 2 shows, in a perspective sectional view in cut-out along a sectional plane indicated by the line II-II in FIG. 1 and extending in the vertical direction of the vehicle or in the longitudinal direction of the vehicle, the arrangement of the reinforcing profile 9 within the cavity 8 formed by the corresponding structural region 7 of the unfinished component 1. In particular, it is apparent that the reinforcing pipe profile 9 is formed in the present case as an internal high-pressure formed part or by internal high-pressure forming and has a substantially polygonal cross-section. Such internal high-pressure formed parts are, for the purpose of production, naturally formed as closed pipe profiles in order to enable corresponding internal high-pressure forming.

The reinforcing hollow profile 9 equally in the present case has a multiplicity of recesses 11 which, in the present case, have been incorporated either during the internal high-pressure forming by means of corresponding slides against the internal pressure of the medium to the internal high-pressure forming or, however, for example, by laser trimming performed subsequently to the internal high-pressure forming or other processing. In the present exemplary embodiment, as is apparent from FIG. 2, the recesses 11 are incorporated in the region of a corresponding leg 12 of the reinforcing pipe profile 9. As a result of this, a respective profile region 13, adjoining the corresponding recess 11, of the reinforcing pipe profile 9 is accessible from the inside via the respective recesses 11.

As a result of this, it is possible that the respective edge or profile regions 13, which adjoin the recesses 11, of the reinforcing pipe profile 9 can be connected in a two-sided connecting method, in particular a two-sided joining method, to the respectively associated unfinished shell part 2, in the present case the inner unfinished shell part of the unfinished component 1. A corresponding two-sided connecting method can be, in particular, a joining method in the form of a spot-welding connecting method. A corresponding spot-welding connection 14 is consequently symbolically indicated in FIG. 2. As an alternative to this, other joining methods or other connecting methods such as, for example, riveting or clinching are also contemplated. In this case, the interior of the reinforcing pipe profile 9 can be accessed via the corresponding recess 11 in order to produce a corresponding two-sided spot-welding connection, for example, by means of welding tongs. Such two-sided connections can consequently be produced with significantly greater ease and at lower cost than hitherto commonplace one-sided connections.

FIG. 3 shows, in a cut-out perspective view, the detail III in FIG. 1 from which the fastening of the reinforcing pipe profile 9 to the unfinished shell part 2 in the region of the corresponding pillar part 4 is illustrated. It is in particular apparent in this case that the unfinished shell part 2 in the pillar region 4, which in this region forms the box-like structural region 7, has a substantially U-shaped cross-section with respective legs 15, 16, wherein these legs 15, 16 adjoin corresponding wall regions 17, 18 of the reinforcing pipe profile 9 which run substantially at a right angle to the leg 12 of the reinforcing pipe profile 9 in which the recesses 11 are arranged. A respective two-sided connection, in particular a two-sided joining connection between the corresponding legs 15, 16 of the unfinished shell part 2 and the wall regions 17, 18 of the reinforcing pipe profile 9 can consequently be produced via each of these recesses 11. Respective spot-welding connections 19 are indicated in the present case.

The reinforcing pipe profile 9 and the unfinished shell part 2 joined thereto are in the present case produced in particular from the same base alloy, for example, a respective steel alloy or aluminum alloy in order to be able to provide a simple joining method, in particular a simple welding method.

The present unfinished component can not only be a tailgate or any other type of tailgate, door, wing element or the like, but rather, for example, also a pillar such as a center pillar or the like. Other pillars, carriers, roof bows, frame elements or the like of the motor vehicle body can also be formed in the manner of the unfinished component 1 described in the present case.

### LIST OF REFERENCE SIGNS

1 Unfinished component
2 Unfinished shell part
3 Cross member element
4 Pillar parts
5 Support structure
6 Door edge molding
7 Structural region
8 Cavity
9 Reinforcing hollow profile
9 Reinforcing pipe profile
10 Linking points
11 Recess
12 Leg
13 Profile region
14 Spot-welding connection
15 Leg
17 Wall regions
19 Spot-welding connections

1.-10. (canceled)

11. An unfinished component for a motor vehicle body, comprising:
a first and a second unfinished shell part which delimit a cavity in a box-shaped structural region;
a reinforcing pipe profile arranged in the cavity and being connected to at least one of the first and second unfinished shell parts by a connection, wherein
in each case, recesses are arranged in the reinforcing pipe profile, in adjoining profile regions of which recesses the reinforcing pipe profile is connected via respective two-sided connections to an associated one of the first and second unfinished shell parts.

12. The unfinished component according to claim 11, wherein
the reinforcing pipe profile is connected to the associated unfinished shell part via respective two-sided joining connections.

13. The unfinished component according to claim 11, wherein
the reinforcing pipe profile is formed as an internal high-pressure formed part into which the respective recesses are incorporated during or after the internal high-pressure forming.

14. The unfinished component according to claim 11, wherein
the unfinished component is formed as a wing part of the vehicle body.

15. The unfinished component according to claim 14, wherein
the wing part is a tailgate, door or hood.

16. The unfinished component according to claim 14, wherein
an inner one of the unfinished shell parts is joined to the reinforcing pipe profile.

17. The unfinished component according to claim 14, wherein
the unfinished shell part joined to the reinforcing pipe profile has a substantially U-shaped cross-section in the box-like structural region.

18. The unfinished component according to claim 17, wherein
the unfinished shell part is joined in the region of the U-shaped cross-section at opposite legs to the reinforcing pipe profile via respective joining connections.

19. The unfinished component according to claim 11, wherein
the reinforcing pipe profile and the unfinished shell part connected thereto are formed from base alloys of the same materials.

20. A method for producing an unfinished component for a motor vehicle body, the method comprising:
connecting a first and a second unfinished shell part to one another so as to delimit a cavity in a box-shaped structural region, in which cavity a reinforcing pipe profile is arranged which is connected to at least one of the first and second unfinished shell parts by a joining connection;
incorporating respective recesses into the reinforcing pipe profile, in adjoining profile regions of which recesses the reinforcing pipe profile is connected via respective two-sided connections to an associated one of the first and second unfinished shell parts.

21. The method according to claim 20, wherein
the reinforcing pipe profile is connected to the associated unfinished shell part via respective two-sided joining connections.
